(19) United States
(12) Patent Application Publication
(10) Pub. No.: US 2004/0218565 A1
(43) Pub. Date: Nov. 4, 2004

(54) Method of operating a base station

(75) Inventor: Simon Paul Davis, Romsey (GB)

Correspondence Address: CROWELL & MORING LLP, INTELLECTUAL PROPERTY GROUP, P.O. BOX 14300, WASHINGTON, DC, 20044-4300, US

(73) Assignee: SIEMENS AKIENGESELLSCHAFT AG, Munich (DE)

(21) Appl. No.: 10/772,407

(22) Filed: Feb. 6, 2004

(30) Foreign Application Priority Data
Feb. 28, 2003 (GB) 0304500.2

(51) Int. Cl. H04Q 7/00

(52) U.S. Cl. 370/331

(57) ABSTRACT

A method of operating a base station system comprising at least one base station controller (BSC); the method comprising controlling receipt of data from a streaming source (1); wherein the data from the streaming source is stored in a buffer (5) in the BSC (4) when a mobile station (MS) is communicating via a first cell; and transmitted to the MS (6) from the BSC buffer at a first data rate via the first cell; wherein the BSC monitors the MS and on receipt of an indication that the MS has ceased communication via the first cell, the BSC prevents further streaming data from entering the BSC buffer; wherein the BSC monitors for an indication that the MS has set up communication via a second cell; and on receipt of such an indication, instructs the streaming source to continue data transfer via the second cell; wherein a BSC (8) in the second cell instructs the streaming source to increase the rate of data transfer to the MS buffer (7) via the second cell until the MS buffer is substantially refilled; and thereafter to continue data transfer at the first data rate.

This invention relates to a method of operating a base station system.

The provision of real time streaming services in a mobile environment gives rise to particular problems. It is desirable to carry voice over internet protocol (VOIP) and video streaming services using the extended GPRS system until GERAN is widely available. This includes such facilities as accessing the radio via the Internet or downloading video clips. In a communication network there may be a streaming source roadcasting packets to the network. The source of the streaming service, such as real-audio streaming for the Internet, cannot be stopped, sped-up, slowed down or repeated to satisfy the requirements of a single user. The source is started and all users receiving the service play a passive role. Conventionally, data from the streaming service is buffered in packets in a serving GPRS support node (SGSN) buffer and transferred from there to a buffer in a mobile station (MS), generally via a base station controller (BSC) which has a small amount of buffering available. Flow control operated by the BSC prevents too much data being sent from the SGSN, which could cause the BSC buffer to overflow and the MS does not start to run the application until its buffer is almost full to avoid the effect of jitter appearing. The data transmitted may have jitter which needs to be filtered out before the end user.

A particular problem is when a mobile station moves out of range of a first cell from which it was receiving the service and into range of another cell. During and immediately after the transition period, there may be a loss of data and consequent reduction in the quality of the service received by that mobile station.

In accordance with a first aspect of the present invention, a method of operating a base station system comprising at least one base station controller (BSC); comprises controlling receipt of data from a streaming source; wherein the data from the streaming source is stored in a buffer in the BSC when a mobile station (MS) is communicating via a first cell; and transmitted to the MS from the BSC buffer at a first data rate via the first cell; wherein the BSC monitors the MS and on receipt of an indication that the MS has ceased communication via the first cell, the BSC prevents further streaming data from entering the BSC buffer; wherein the BSC monitors for an indication that the MS has set up communication via a second cell; and on receipt of such an indication, instructs the streaming source to continue data transfer via the second cell; wherein a BSC in the second cell instructs the streaming source to increase the rate of data transfer to the MS buffer via the second cell until the MS buffer is substantially refilled; and thereafter to continue data transfer at the first data rate.

Preferably, the streaming data is stored in a store in a serving GPRS support node (SGSN) before being transmitted to the BSC buffer.

Preferably, the SGSN measures a service interruption time and determines the required increased rate of data transfer and the period for which that data transfer rate shall be maintained therefrom.

In accordance with a second aspect of the present invention, a handover method in a general packet radio service (GPRS) system comprises receiving data from a streaming source in a serving GPRS support node (SGSN), transmitting data to a mobile station (MS) at a first data rate via a first cell; storing the data in a buffer in the MS; and running an application on the MS from the buffer; wherein on receipt of an indication that the MS has ceased communication via the first cell; instructing the SGSN to store data in its buffer; monitoring for an indication that the MS has set up communication via a second cell; and continuing data transfer via the second cell; wherein the rate of data transfer from the SGSN to the MS buffer via the second cell is increased until the MS buffer is substantially refilled; and thereafter continuing data transfer at the first data rate.

The invention reduces the buffering requirement in the SGSN, whilst minimising the chance of loss of service due to the depletion of the buffer in the MS. Conventionally the fill state of the buffer in the MS would be reduced as a result of the cell change and a subsequent cell change may cause it to be depleted causing a discontinuity in the streaming service. This would normally be a gap where the service was denied to the user whilst the MS buffer was refilled.

The time for which data transfer continues at the higher bit rate could be controlled by sending a signal back from the MS buffer when that buffer is nearly full, but this suffers from complications, so preferably, the SGSN measures a service interruption time and determines the required increased rate of data transfer therefrom.

Preferably, the increased data rate is set between an original guaranteed bit rate and a peak rate.

Preferably, the rate of data transfer is increased by changing the guaranteed bit rate.

Typically, data transfer from the SGSN to the MS is controlled by a base station controller (BSC). This is contained within a base station subsystem.

Various streaming sources may benefit from the invention, but preferably, the streaming source comprises real-audio streaming from the Internet, or video.

An example of a handover method in a GPRS system according to the present invention will now be described with reference to the accompanying drawings in which:

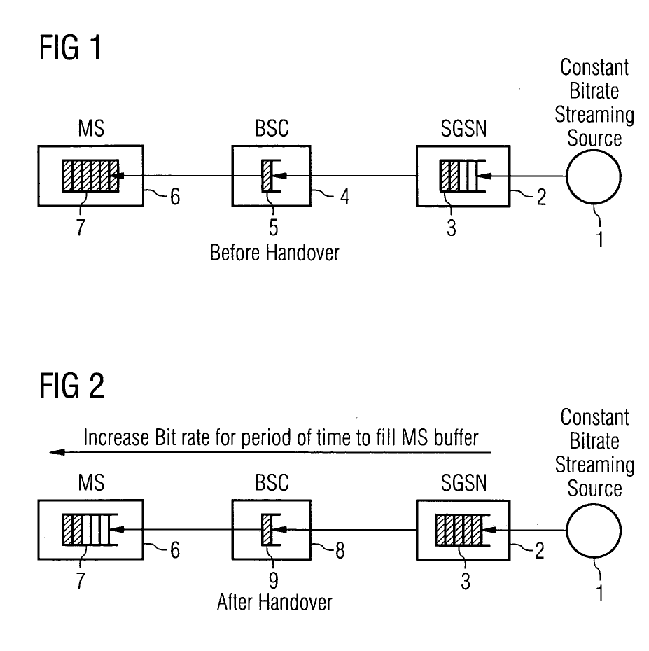

FIG. 1a illustrates buffering for a GPRS system before using the handover method of the present invention; and,

FIG. 2 illustrates buffering during operation of a handover method according to the present invention.

FIG. 1 illustrates how a GPRS system provides streaming data to a MS user via a first cell for an application, before a handover occurs. The kind of streaming service envisaged here is something like real-audio streaming for the Internet where many users are receiving a constant bit rate stream from a single source. In the Internet an end-user (PC) will start the session by buffering up a sufficient amount of data to avoid buffer under-runs due to the jitter experienced in the network. If a buffer under-run occurs, a significant gap in the service is experienced while the initial buffering takes place again.

A streaming data source 1 sends data at a constant bit rate to an SGSN 2 which stores the data in its buffer 3. Under control of a BSC 4 the data is transferred to a BSC buffer 5, which has only a small capacity, and from there data is input to an MS 6. Only when a buffer 7 in the MS is nearly full, will the MS start to run the application.

Whilst the application is running, the MS moves out of range of the first cell. In the example shown in FIG. 2, the SGSN 2 remains the same for the next cell to which the MS connects, but this is not always the case. It is relatively rare for a change of SGSN to occur, but if it did, then either the data in the first SGSN will be transferred to the second SGSN via the core network thus leading to increased interruption time, but no loss of data; or the data in the first SGSN will be discarded.

As soon as the MS disconnects from the first cell, the MS buffer stops receiving data, but the application continues to run, using the data already stored in the MS buffer. It could take as much as 5 seconds to transfer to the new cell, so that the amount of buffered data available in the MS to prevent jitter is significantly reduced by the time that the transfer has taken place. The application continues to run from the MS buffer during the transfer from the first cell to the second cell, so the MS must have sufficient buffering to take account of this.

Meanwhile, the data from the streaming service is filling up the SGSN buffer because the old BSC 4 will not permit data to be transferred now that the MS has disconnected from the old BSC. As the MS connects to the next cell, a BSC 8 associated with that new cell takes over and permits data stored in the SGSN buffer 3 to be downloaded again to the MS 6 via a new BSC buffer 9. However, at this point there is a risk that the MS buffer is nearly empty because of the disconnection period and the quality of the service may diminish. Furthermore, it is not ideal to fill up the SGSN buffer because it is limited in size, shared amongst other users and it is in the interests of the network operator or equipment vendor to reduce buffering in the SGSN. In addition the MS may not have enough data buffered to allow a subsequent lossless handover. To prevent this, the present invention causes the rate of data transfer from the now, nearly full, SGSN buffer 3 to be increased to replenish the MS buffer 7 more quickly. The SGSN signals to the BSC 8 that it needs to increase the rate of download to the MS. The SGSN knows how long the gap between connections was and also the rate of download of the data in the meantime, so it will control the length of time for which the faster download rate applies. It then reverts to the standard download rate to maintain the buffer as protection of the user against another cell change. When this state has been reached the rate can be reduced to the original service rate.

The BSC controls quality of service (QoS). One aspect of this is the defined guaranteed bit rate, which is the minimum rate at which data is transferred to the MS if there is congestion due to all radio resources being used. This is normally derived from the service requirement (streaming) and would be expected to be constant throughout the session. The actual bit rate may be greater than this. The other is the peak rate. When an initial connection is made, a guaranteed bit rate is determined. To ensure that the data transfer after a handover takes place at the desired rate, the guaranteed bit rate can be increased until the MS buffer is sufficiently full, then brought back to its original bit rate. The increase can be to any value below the peak bit rate according to the rate determined by the SGSN.

The normal bit rate of the service can be mapped to the guaranteed bit rate quality of service (QoS) parameter and the higher rate can be mapped to the maximum bit rate QoS parameter. Thus the bit rate involved can be known by all of the network entities.

There are two basic approaches to deciding how long the higher bit rate or maximum bit rate will be used for. The first is to have a flow control message from the MS to the SGSN to say that its buffer is nearly full. This approach suffers from several problems. First, it is unclear as to which protocol layer should respond (it may even be application specific). Second, there may be a variable delay in the message reaching the SGSN.

Another approach is for the SGSN to calculate the time period required to send at the higher bit rate based on the measured service interruption time. This is the referred solution as all the functionality is maintained in one network node, the SGSN, and it is independent of the MS application and protocol stack. Such a mechanism could temporarily update the QoS parameters contained in the base station subsystem packet flow context (BSS (PFC)) for a period of time (seconds) until the MS buffer is restored to its previous fill state or until the SGSN buffer becomes empty. The SGSN can then update the BSS (PFC) again to restore old parameters.

When the system is lightly loaded, it is not necessary to change the rate of download from the SGSN because the SGSN is designed to send data through as quickly as possible anyway to reduce the content of its buffer.

1. A method of operating a base station system comprising at least one base station controller (BSC); the method comprising controlling receipt of data from a streaming source; wherein the data from the streaming source is stored in a buffer in the BSC when a mobile station (MS) is communicating via a first cell; and transmitted to the MS from the BSC buffer at a first data rate via the first cell; wherein the BSC monitors the MS and on receipt of an indication that the MS has ceased communication via the first cell, the BSC prevents further streaming data from entering the BSC buffer; wherein the BSC monitors for an indication that the MS has set up communication via a second cell; and on receipt of such an indication, instructs the streaming source to continue data transfer via the second cell; wherein a BSC in the second cell instructs the streaming source to increase the rate of data transfer to the MS buffer via the second cell until the MS buffer is substantially refilled; and thereafter to continue data transfer at the first data rate.

2. A method according to claim 1, wherein the streaming data is stored in a store in a serving GPRS support node (SGSN) before being transmitted to the BSC buffer.

3. A method according to claim 2, wherein the SGSN measures a service interruption time and determines the required increased rate of data transfer and the period for which that data transfer rate shall be maintained therefrom.

4. A method according to claim 1, wherein the increased data rate is set between an original guaranteed bit rate and a peak rate.

5. A method according to claim 1, wherein the rate of data transfer is increased by changing the guaranteed bit rate.

6. A method according to claim 1, wherein the streaming source comprises real-audio streaming from the Internet, or video.

7. A handover method in a general packet radio service (GPRS) system, the method comprising receiving data from a streaming source in a serving GPRS support node (SGSN), transmitting data to a mobile station (MS) at a first data rate via a first cell; storing the data in a buffer in the MS; and running an application on the MS from the buffer; on receipt of an indication that the MS has ceased communication via the first cell; instructing the SGSN to store data in its buffer; monitoring for an indication that the MS has set up communication via a second cell; and continuing data transfer via the second cell; wherein the rate of data transfer from the SGSN to the MS buffer via the second cell is increased until the MS buffer is substantially refilled; and thereafter continuing data transfer at the first data rate.

8. A method according to claim 7, wherein the SGSN measures a service interruption time and determines the required increased rate of data transfer therefrom.

9. A method according to claim 8, wherein the increased data rate is set between an original guaranteed bit rate and a peak rate.

10. A method according to claim 9, wherein the rate of data transfer is increased by changing the guaranteed bit rate.

11. A method according to claim 7, wherein data transfer from the SGSN to the MS is controlled by a base station controller.

12. A method according to claim 7, wherein the streaming source comprises real-audio streaming from the Internet, or video.
